(19) United States
(12) Patent Application Publication
(10) Pub. No.: US 2024/0123912 A1
(43) Pub. Date: Apr. 18, 2024

(54) VEHICLE-MOUNTED DEVICE FOR FIXING BICYCLE

(71) Applicant: Baorong Wang, Ningbo City (CN)

(72) Inventor: Baorong Wang, Ningbo City (CN)

(73) Assignee: Ningbo Tuoluzhe Auto Accessories Co., Ltd., Ningbo City (CN)

(21) Appl. No.: 18/534,688

(22) Filed: Dec. 10, 2023

(30) Foreign Application Priority Data
Dec. 16, 2022 (CN) 2022116281264
Aug. 29, 2023 (CN) 2023223402668

(51) Int. Cl. B60R 9/10; B60R 9/048

(52) U.S. Cl. CPC B60R 9/10; B60R 9/048

(57) ABSTRACT

Disclosed is a vehicle-mounted device for fixing a bicycle. The device includes: a connecting frame; a fixing frame rotatably arranged at one end or two ends of the connecting frame; an angle adjustment device connected to the connecting frame and the fixing frame separately and configured to adjust an angle of the fixing frame relative to the connecting frame; and locking devices movably arranged on the connecting frame and the fixing frame and configured to fix a front wheel and a rear wheel of the bicycle to the connecting frame and/or the fixing frame. The vehicle-mounted device for fixing a bicycle according to the present disclosure can conveniently adjust positions of the locking devices according to a size of wheels, and can keep the bicycle in a vertical state by means of the fixing frame, such that a moment arm received by the wheels is reduced.

### TECHNICAL FIELD

The present disclosure relates to an auxiliary device of an automobile, and particularly relates to a vehicle-mounted device for fixing a bicycle.

### BACKGROUND

People may carry a bicycle for later riding when driving out for travel or sports. In order to carry the bicycle, they generally arrange a device for fixing a bicycle on a roof and fix the bicycle by means of this device. For instance, the Chinese patent CN201922299943X disclosed a device for fixing a bicycle to an automobile top. Its user mounts the device on a roof rack at the automobile top by means of a mounting support, and loosens an adjustment screw rod, such that a first fixing support can slide along a through groove. Then, the user places a wheel of the bicycle a placement recess, and adjusts an angle between a second fixing support and the first fixing support, such that the second fixing support and the first fixing support abut against two sides of the wheel. After that, the user tightens the adjustment screw rod so as to lock the wheel in the placement recess, and rotates a fastening screw rod to drive two screw sleeves to move in opposite directions. Further, two sliding blocks are driven to move close to each other, such that locking heads are stuck at the two sides of the wheel of the bicycle. Due to an elastic force of a reset spring, the wheel is kept locked, such that fixation of the bicycle is completed. While the automobile runs, a damping spring can reduce its vibration, and a connecting belt can further reduce a shaking amplitude of a bearing plate. The elastic force of the reset spring acts to lock the wheel and prevent the bicycle from falling over. Only one end of the wheel is stuck with the locking heads at the two sides of the wheel, which makes fixation of the bicycle unstable, and achieves a large moment arm. These problems will cause deformation of a hub of the wheel and make the device inconvenient to use.

### SUMMARY

In order to solve the problems of unstable bicycle fixation and inconvenient use, the present disclosure provides a vehicle-mounted device for fixing a bicycle, which has a specific technical solution as follows:

A vehicle-mounted device for fixing a bicycle includes: a connecting frame; a fixing frame rotatably arranged at one end or two ends of the connecting frame; an angle adjustment device connected to the connecting frame and the fixing frame separately and configured to adjust an angle of the fixing frame relative to the connecting frame; and locking devices movably arranged on the connecting frame and the fixing frame and configured to fix a front wheel and a rear wheel of the bicycle to the connecting frame and/or the fixing frame.

Preferably, the locking device includes a positioning plate and a fastening device or includes a positioning plate, a fastening device, and a binding device. The positioning plate is movably arranged on the connecting frame and the fixing frame. The fastening devices are movably arranged on the connecting frame and the fixing frame and connected to the positioning plates, and are configured to fix the positioning plates to the connecting frame and the fixing frame. The binding device is mounted on the fastening device on the connecting frame, and is configured to lock the rear wheel on the positioning plate.

Preferably, the positioning plate is provided with a positioning recess.

Preferably, the fastening device includes: a pressing plate, where the pressing plate is arranged opposite the positioning plate; a positioning screw, where the positioning screw is arranged on the positioning plate; and a positioning nut arranged on the pressing plate, connected to the positioning screw, and configured to press the pressing plate and the positioning plate on each of the fixing frame and the connecting frame.

The binding device is mounted on the pressing plate on the connecting frame.

Preferably, the binding device includes: a ribbon arranged at one end of the fastening device; and an elastic fastener arranged at the other end of the fastening device and arranged opposite the ribbon. The ribbon is configured to bind the rear wheel of the bicycle to the positioning plate by means of the elastic fastener.

Further, the vehicle-mounted device for fixing a bicycle further includes: upper positioning seats, where the upper positioning seats are mounted at two ends of the positioning plate; and lower positioning seats, where the lower positioning seats are mounted at two ends of the pressing plate and arranged opposite the upper positioning seats. The upper positioning seats and the lower positioning seats are configured to slide to abut against the fixing frame and the connecting frame.

The upper positioning seats are provided with upper pressing recesses. The upper pressing recesses are slidably connected to the fixing frame and the connecting frame in an inserted manner.

The lower positioning seats are provided with lower pressing recesses. The lower pressing recesses are slidably connected to the fixing frame and the connecting frame in an inserted manner.

Preferably, the connecting frame includes: connecting supports, where the connecting supports are U-shaped, and the number of the connecting supports is two; and a connecting plate connected to the two connecting supports separately.

Preferably, the angle adjustment device includes: a rotating seat arranged on the fixing frame; a ratchet wheel arranged on the connecting frame; a pawl, where the pawl is rotatably mounted on the rotating seat and provided with a rocker; and a spring, where the spring is connected to the rotating seat and the pawl separately, such that the pawl meshes with the ratchet wheel.

Preferably, the vehicle-mounted device for fixing a bicycle further includes: a protective shell arranged on the fixing frame. The angle adjustment device is located in the protective shell.

Compared with the prior art, the present disclosure has the beneficial effects:

The vehicle-mounted device for fixing a bicycle according to the present disclosure can conveniently adjust positions of the locking devices according to a size of wheels, and can keep the bicycle in a vertical state by means of the fixing frame, such that a moment arm received by the wheels is reduced. In this way, not only reliable fixing of the wheels can be ensured, but also deformation of the wheels can be avoided. By means of the angle adjustment device, the connecting frame can be conveniently folded, and meanwhile, the bicycle can be conveniently loaded and taken out. The vehicle-mounted device is convenient in use and simple in structure.

### BRIEF DESCRIPTION OF THE DRAWINGS

FIG. 1 is a schematic structural diagram of Example 1 in an unfolded state.

FIG. 2 is a schematic structural diagram of Example 1 in a folded stat.

FIG. 3 is a schematic structural diagram of a locking device.

FIG. 4 is a front view of a locking device.

FIG. 5 is an explosive view of a locking device.

FIG. 6 is a schematic structural diagram of a positioning plate.

FIG. 7 is a schematic structural diagram of a pressing plate.

FIG. 8 is a space diagram of a lower positioning seat from a first viewing angle.

FIG. 9 is a space diagram of a lower positioning seat from a second viewing angle.

FIG. 10 is a schematic assembly diagram of a connecting tube and a support seat.

FIG. 11 is a schematic structural diagram of a support seat.

FIG. 12 is a schematic structural diagram of an angle adjustment device.

FIG. 13 is a cutaway view of an angle adjustment device.

FIG. 14 is a schematic structural diagram of a protective shell.

FIG. 15 is a schematic diagram of fixing a bicycle in Example 1.

FIG. 16 is a schematic structural diagram of Example 2 in a folded state.

FIG. 17 is a schematic diagram of Example 2 mounted on a vehicle-mounted tail bracket in a folded state.

FIG. 18 is a schematic diagram of Example 2 mounted on a vehicle-mounted tail bracket in an unfolded state.

FIG. 19 is a schematic diagram of fixing a bicycle in Example 2.

FIG. 20 is a cutaway view of a binding device fixing a rear wheel.

### DETAILED DESCRIPTION OF THE EMBODIMENTS

The present disclosure will be further described with reference to the accompanying drawings.

### Example 1

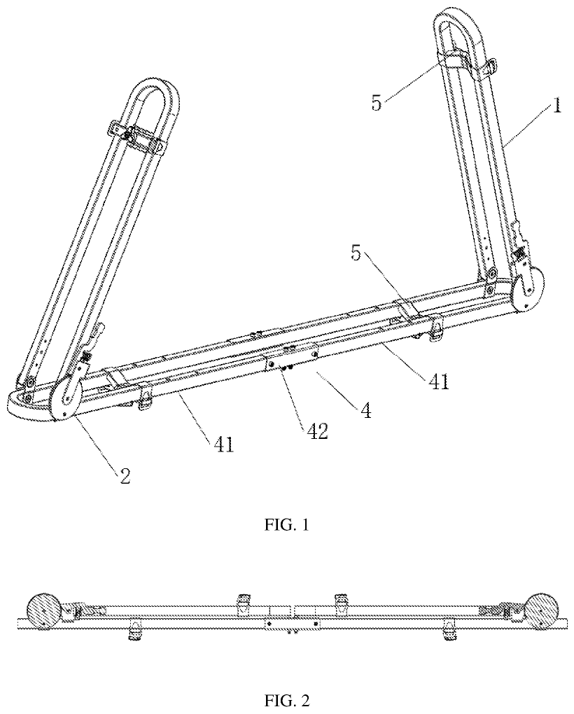

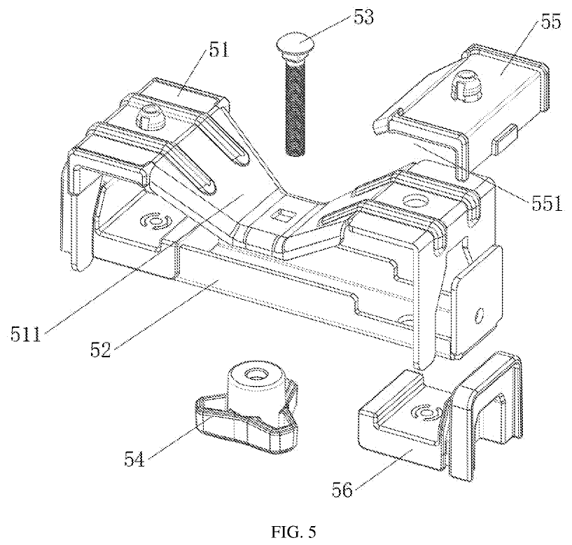

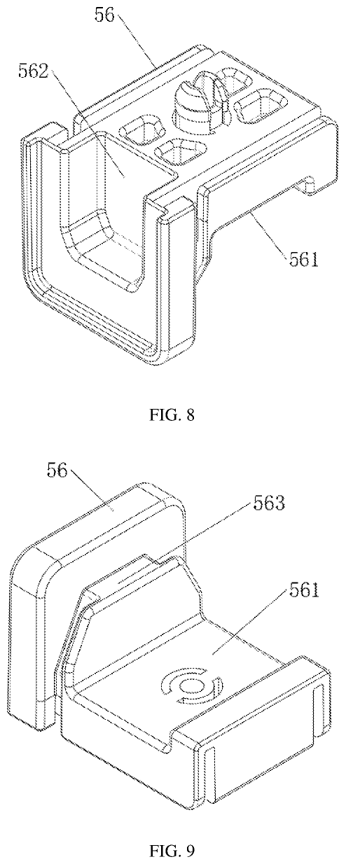

As shown in FIGS. 1-14, a vehicle-mounted device for fixing a bicycle includes a connecting frame 4, fixing frames 1, an angle adjustment device 2, and locking devices 5. The connecting frame 4 is configured to be fixed to a roof or a vehicle-mounted tail bracket 8, and the fixing frames 1 are rotatably mounted at two ends of the connecting frame 4. The angle adjustment device 2 is connected to the connecting frame 4 and the fixing frame 1 separately and configured to adjust an angle of the fixing frame 1 relative the connecting frame 4. The locking devices 5 are movably mounted on the connecting frame 4 and the fixing frame 1 and configured to fix a front wheel 71 and a rear wheel 72 of the bicycle to the connecting frame 4 and the fixing frame 1.

The locking devices 5 make the wheels stuck in the fixing frame 1 and the connecting frame 4, such that the wheels are fixed.

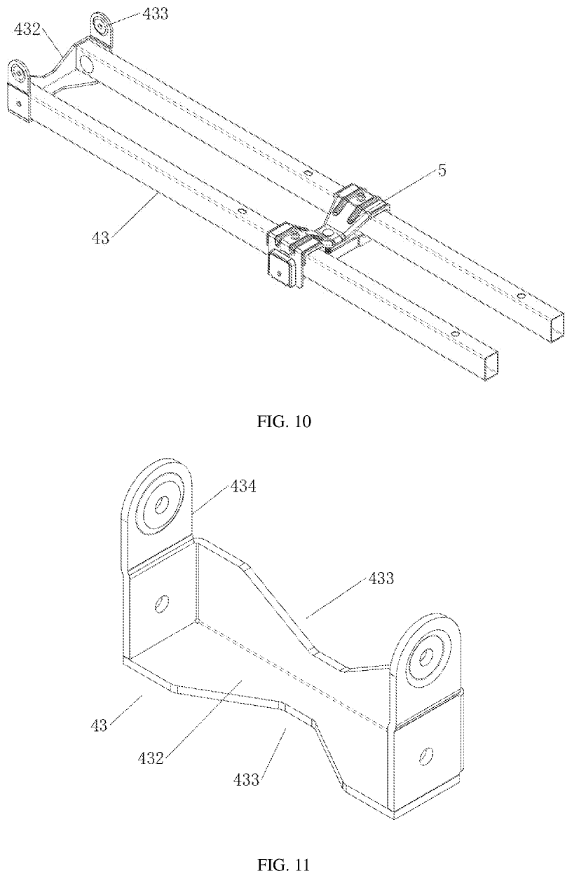

Specifically, as shown in FIG. 1, the connecting frame 4 includes connecting supports 41 and a connecting plate 42. The connecting supports 41 are U-shaped, and the number of the connecting supports is two. The connecting plate 42 is connected to the two connecting supports 41 separately. The connecting support 41 may be formed by bending a tube, for instance, by bending a square tube into a U-shape. Alternatively, the connecting support consists of two connecting tubes 44 and a support seat 43. The two connecting tubes 44 are symmetrically arranged, and the support seat 43 is fixed to one end of the connecting support 41, such that a U-shaped structure is formed, as shown in FIGS. 10 and 11. The support seat 43 is provided with a hinge plate 434 and a wheel recess 433, and the hinge plate 434 is hinged to an end of the fixing frame 1. The wheel recesses 433 are located on two sides of the support seat 43, and provided opposite the wheel, such that the wheel may be stuck in the wheel recesses 433. The support seat 43 is formed through plate stamping. The support seat 43 not only facilitates connection of two front branch tubes 431, but also facilitates rotational connection of the fixing frame 1, which makes a structure simple and decreases cost. A cross section of the connecting plates 42 is U-shaped, and the number of the connecting plates 42 is four. Each two of the connecting plates constitute a group and are connected to the connecting support 41 by means of screws separately, and the U-shaped connection plates 42 are high in strength. The connecting plates 42 can be conveniently manufactured and disassembled, such that the connecting frame 4 is divided into three parts. A length of the connecting frame can be reduced, the connecting frame can be conveniently stored, and the connecting frame can be placed in a trunk.

As shown in FIG. 1, the fixing frame 1 has the same structure as the connecting support 41, both of which are U-shaped and formed by bending a square tube. The U-shaped structure can not only allow the wheel to be conveniently inserted into and fix the wheel, but also has high strength.

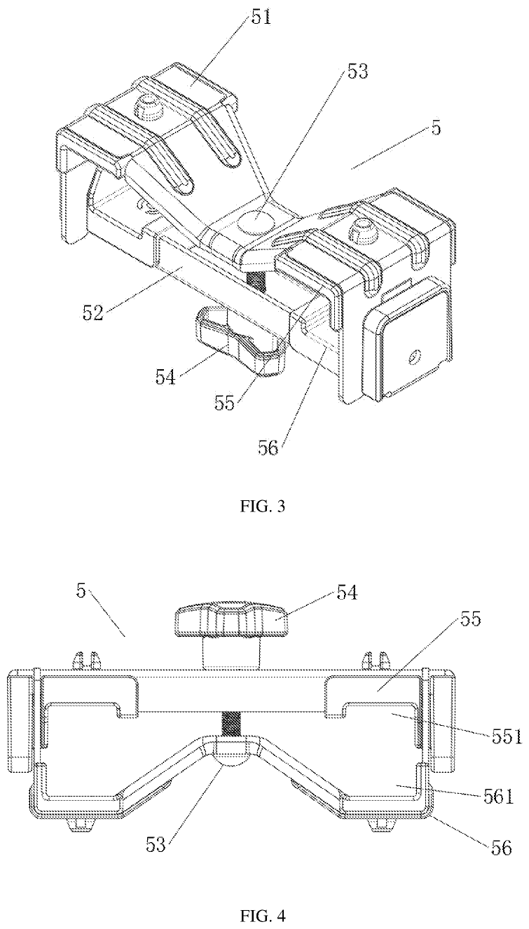

As shown in FIGS. 3-9, the locking device 5 includes a positioning plate 51 and a fastening device. The positioning plate 51 is movably arranged on the connecting frame 4 and the fixing frame 1. The fastening devices are movably arranged on the connecting frame 4 and the fixing frame 1 and connected to the positioning plates 51, and are configured to fix the positioning plates 51 to the connecting frame 4 and the fixing frame 1.

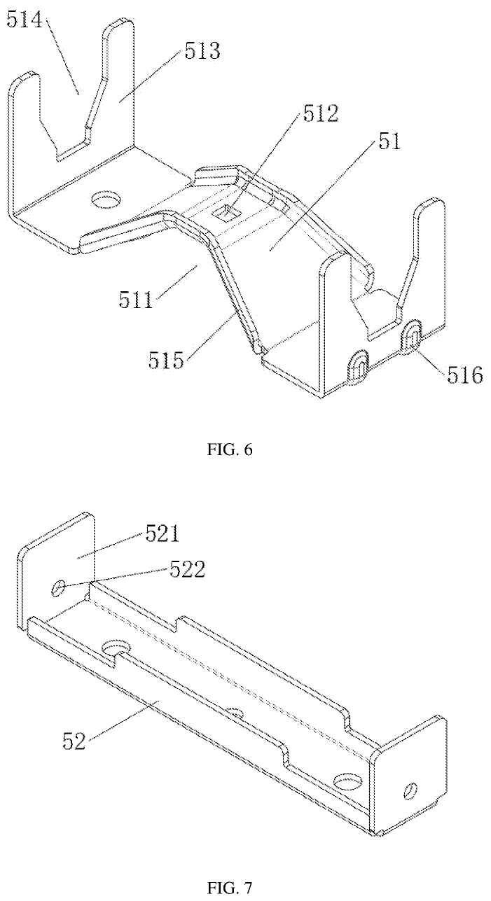

As shown in FIG. 6, the positioning plate 51 is W-shaped, and a center of the positioning plate is provided with a positioning recess 511 that is concave inwards. Two ends of the positioning plate 51 are symmetrically provided with side baffles 513, and the side baffles 513 are provided with lifting recesses 514. Two sides of the positioning plate 51 are symmetrically provided with reinforcing flanges 515, and reinforcing ribs 516 are arranged between the positioning plate 51 and the side baffles 513. Both the reinforcing flanges 515 and the reinforcing ribs 516 improve strength of the positioning plate 51, such that the positioning plate 51 can be prevented from being deformed, and clamping reliability can be improved. A center of the positioning recess 511 is provided with a square hole 512. An upper positioning seat 55 is mounted on the positioning plate 51 and located at one side of the side baffle 513.

As shown in FIGS. 3-9, the fastening device includes a pressing plate 52, a positioning screw 53, an upper positioning seat 55, and a lower positioning seat 56. Two sides of the pressing plate 52 are symmetrically provided with pressing connecting plates 521, and the pressing connecting plates 521 are provided with threaded holes 522. The pressing plate 52 is arranged opposite the positioning plate 51, which are located on two sides of each of the connecting frame 4 and the fixing frame 1, respectively. The lower positioning seat 56 is provided with a lower pressing recess 561. A side surface of the lower positioning seat is provided with a screw recess 562. The lower positioning seats 56 are mounted at two ends of the pressing plate 52 and connected to the connecting plate 42. Meanwhile, the screw recess 562 is in communication with the threaded hole 522. The lower positioning seat 56 is arranged opposite the upper positioning seat 55 and is configured to be pressed on the connecting frame 4 and the fixing frame 1. The lower pressing recesses 561 are movably connected to the connecting frame 4 and the fixing frame 1 in an inserted manner, so as to play a guiding role when the front fastening device is moved, and avoid falling off of the fastening device. The lower positioning seat 56 is provided with a limiting block 563. A lifting recess 514 is movably connected to the limiting block 563 in an inserted manner. The lifting recess 514 and the limiting block 563 keep relative positions of the pressing plate 52 and the positioning plate 51 unchanged, such that a user can conveniently loose hands to move the fastening device. The upper positioning seat 55 is provided with an upper pressing recess 551. The upper pressing recess 551 is provided opposite the lower pressing recess 561. The upper pressing recesses 551 are movably connected to the connecting frame 4 and the fixing frame 1 in an inserted manner. The positioning screw 53 is mounted in a square hole 512 on the positioning plate 51, and an end of the positioning screw 53 matches the square hole 512, such that the positioning screw 53 can be prevented from rotating. The positioning screw 53 further movably penetrates the pressing plate 52, and then is connected to a positioning nut 54. The positioning nut 54 is provided with a handle nut, which can facilitate rotation. The positioning nut 54 is located at one side of the pressing plate 52, and is configured to press the pressing plate 52 and the positioning plate 51 to be movably connected to each of the connecting frame 4 and the fixing frame 1 in an inserted manner.

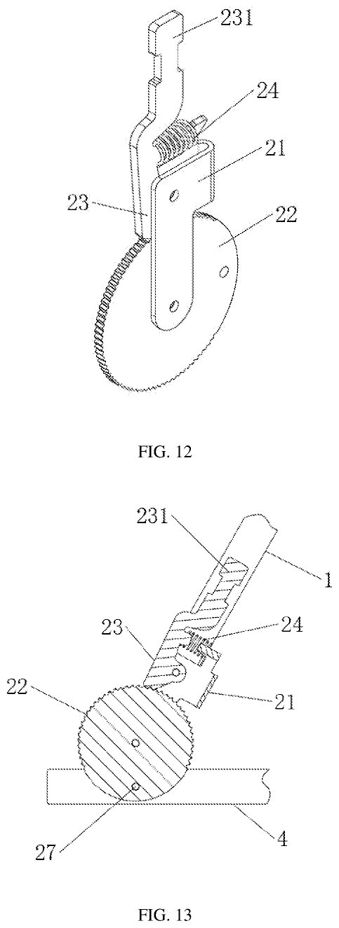

As shown in FIGS. 12 and 13, the angle adjustment device 2 includes a rotating seat 21, a ratchet wheel 22, a rocker 231, a pawl 23, a spring 24, and a positioning shaft 27. The rotating seat 21 has a U-shaped structure. The rotating seat 21 is fixed to an outer side of the fixing frame 1 and located at one end of the connecting frame 4. The ratchet wheel 22 is movably inserted into the rotating seat 21 and rotatably mounted on the fixing frame 1. The positioning shaft 27 is further mounted between the ratchet wheel 22 and the connecting frame 4, and the positioning shaft 27 can prevent the ratchet wheel 22 from rotating. The pawl 23 is movably located in the rotating seat 21 and is rotatably connected to the rotating seat 21. The pawl 23 is further located at one side of the ratchet wheel 22. The pawl 23 is provided with the rocker 231. Two ends of the spring 24 are connected to the rocker 231 and the pawl 23, respectively, such that the pawl 23 meshes with the ratchet wheel 22.

As shown in FIG. 14, the angle adjustment device 2 is further located in the protective shell 25, such that foreign objects can be prevented from entering the pawl 23, the ratchet wheel 22 and the spring 24, and the device can be more beautiful and safe. The rocker 231 is provided with a sleeve handle 26, and the sleeve handle 26 increases a width of the rocker 231, which facilitates poking.

When the angle adjustment device 2 is used, an angle of the fixing frame 1 can be rotated through poking of the pawl 23, such that a distance between the fixing frame and the wheel can be conveniently adjusted, and the fixing frame 1 at one end can be rotated outward to a horizontal or more inclined state. The wheel can be conveniently inserted into the fixing frame 1 at the other end. When the pawl 23 is released, the pawl 23 abuts against the ratchet wheel 22 under the action of the spring 24, and the fixing frame 1 is positioned. When the angle adjustment device is not used, the fixing frame 1 can be folded above the connecting frame 4 through poking of the pawl 23, such that influence on running of an automobile is reduced, storage is facilitated after disassembly, and an occupied volume is small.

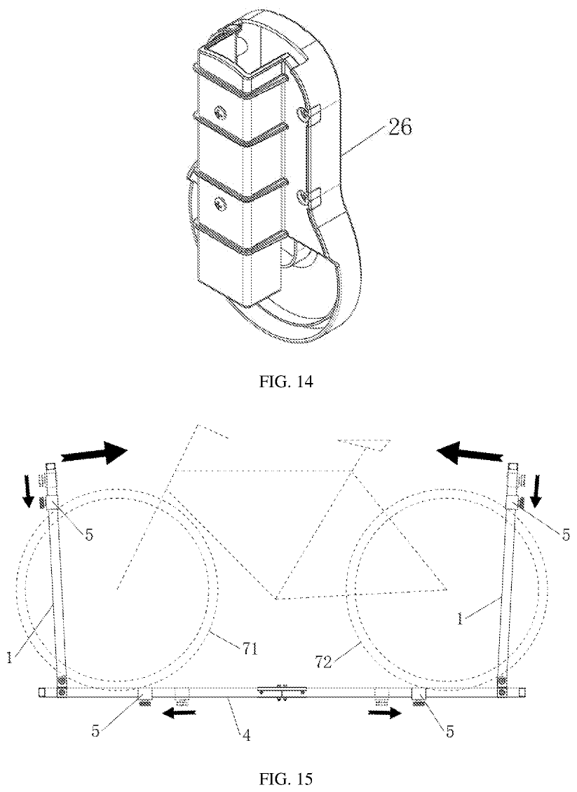

As shown in FIG. 15, the fixing frame 1, the connecting frame 4 and the locking devices 5 are configured to fix the front wheel 71 and the rear wheel 72. The front wheel 71 abuts against positioning recesses 511 of two positioning plates 51 and a wheel recess 433 of a support seat 43, respectively, and three-point positioning of the front wheel 71 is achieved, such that the front wheel 71 is fixed. In a similar way, the rear wheel 72 is fixed, which is convenient to use.

All the parts are reduced and the structure is simpler, such that the cost is effectively reduced and storage is facilitated.

As shown in FIG. 15, during use, the pawl 23 is poked, the angle adjustment device 2 is opened, and the two fixing frames 1 are rotated to appropriate angles separately. The fixing frame 1 configured to fix the front wheel 71 is rotated to a nearly vertical state, and the fixing frame 1 configured to fix the rear wheel 72 may be opened to a larger angle. Then the locking devices 5 are moved to appropriate positions. Then the front wheel 71 of the bicycle is inserted into the fixing frame 1, the angle adjustment device 2 is opened again, and the fixing frame 1 at one side of the rear wheel 72 is rotated reversely, such that the rear wheel 72 is inserted into the fixing frame 1. Then the locking devices 5 on the two fixing frames 1 are adjusted separately, and the rear wheel 72 is pressed on the fixing frame 1 and the connecting frame 4.

### Example 2

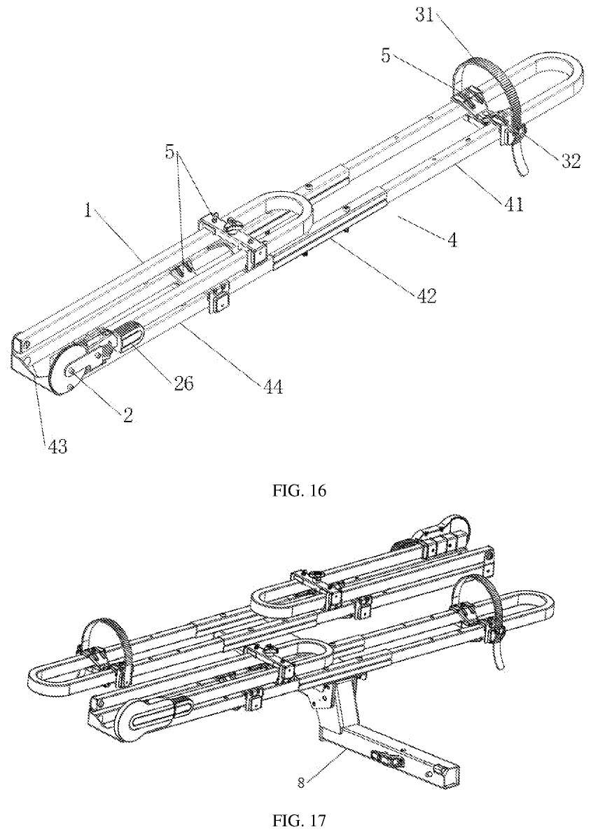

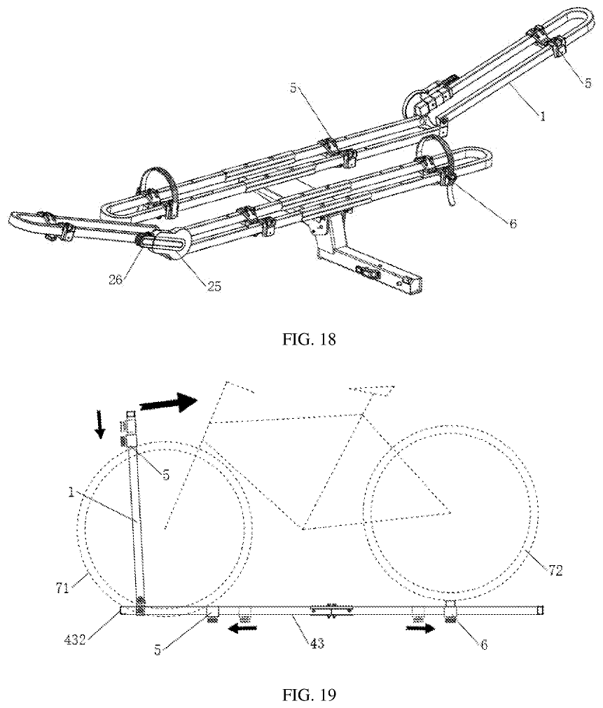

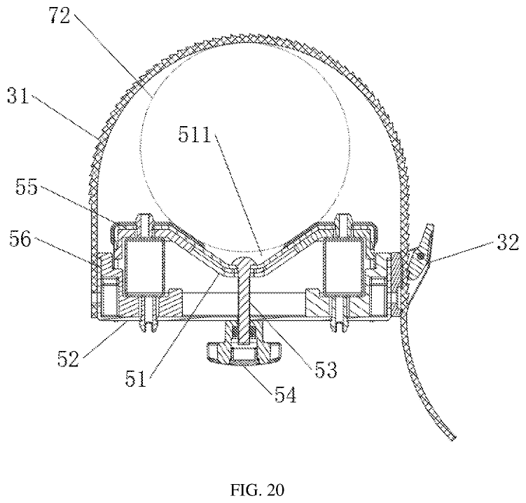

As shown in FIGS. 16-20, the example is different from Example 1 in that the number of a fixing frame 1 is one, and a locking device 5 further includes a binding device, where the binding device is mounted on a fastening device on a connecting frame 4 and is configured to lock a rear wheel 72 on a positioning plate 51. Specifically, a ribbon 31 and an elastic fastener 32 are mounted on a threaded hole 522 by means of screws, and are located at two ends of a pressing plate 52, respectively.

During use, a pawl 23 is poked, an angle adjustment device 2 is opened, a fixing frame 1 is rotated to an appropriate angle, and then the locking device 5 is moved to an appropriate position. Then, a front wheel 71 of a bicycle is inserted into the fixing frame 1, and the rear wheel 72 is located in a positioning recess 511. Then, the ribbon 31 penetrates the rear wheel 72 and is inserted into the elastic fastener 32. The ribbon 31 binds the rear wheel 72 to the positioning plate 51 on the connecting frame 4, and then a position of the bicycle and a position of the locking device 5 are moved as required. When the positions are appropriate, the locking device 5 is tightened, and further the bicycle is fixed. The front wheel 71 of the bicycle is inserted into the fixing frame 1 and cannot rotate. The rear wheel 72 is fixed to the connecting frame 4. In this way, the bicycle is completely fixed, and fixation of the bicycle is facilitated.

All the parts are reduced and the structure is simpler, such that the cost is effectively reduced and storage is facilitated.

A technical principle of the present disclosure is described above with reference to specific examples. What is described is only for explaining the principle of the present disclosure, and cannot be interpreted as limiting the protection scope of the present disclosure in any way. Based on the explanation herein, those skilled in the art can conceive other specific embodiments of the present disclosure without creative efforts, all of which shall fall within the protection scope of the claims of the present disclosure.

1. A vehicle-mounted device for fixing a bicycle, comprising:
a connecting frame (4);
a fixing frame (1) rotatably arranged at one end or two ends of the connecting frame (4);
an angle adjustment device (2) connected to the connecting frame (4) and the fixing frame (1) separately and configured to adjust an angle of the fixing frame (1) relative to the connecting frame (4); and
locking devices (5) movably arranged on the connecting frame (4) and the fixing frame (1) and configured to fix a front wheel (71) and a rear wheel (72) of the bicycle to the connecting frame (4) and/or the fixing frame (1).

2. The vehicle-mounted device for fixing a bicycle according to claim 1, wherein the locking device (5) comprises a positioning plate (51) and a fastening device or comprises a positioning plate (51), a fastening device, and a binding device; the positioning plate (51) is movably arranged on the connecting frame (4) and the fixing frame (1); the fastening devices are movably arranged on the connecting frame (4) and the fixing frame (1) and connected to the positioning plates (51), and are configured to fix the positioning plates (51) to the connecting frame (4) and the fixing frame (1); and the binding device is mounted on the fastening device on the connecting frame (4), and is configured to lock the rear wheel (72) on the positioning plate (51).

3. The vehicle-mounted device for fixing a bicycle according to claim 2, wherein the positioning plate (51) is provided with a positioning recess.

4. The vehicle-mounted device for fixing a bicycle according to claim 2, wherein the fastening device comprises:
a pressing plate (52), wherein the pressing plate (52) is arranged opposite the positioning plate (51);
a positioning screw (53), wherein the positioning screw (53) is arranged on the positioning plate (51); and
a positioning nut (54) arranged on the pressing plate (52), connected to the positioning screw (53), and configured to press the pressing plate (52) and the positioning plate (51) on each of the fixing frame (1) and the connecting frame (4).

5. The vehicle-mounted device for fixing a bicycle according to claim 2, wherein the binding device comprises:
a ribbon (31) arranged at one end of the fastening device; and
an elastic fastener (32) arranged at the other end of the fastening device and arranged opposite the ribbon (31), wherein the ribbon (31) is configured to bind the rear wheel (72) of the bicycle to the positioning plate (51) by means of the elastic fastener (32).

6. The vehicle-mounted device for fixing a bicycle according to claim 4, further comprising:
upper positioning seats (55), wherein the upper positioning seats (55) are mounted at two ends of the positioning plate (51); and
lower positioning seats (56), wherein the lower positioning seats (56) are mounted at two ends of the pressing plate (52) and arranged opposite the upper positioning seats (55); and
the upper positioning seats (55) and the lower positioning seats (56) are configured to slide to abut against the fixing frame (1) and the connecting frame (4).

7. The vehicle-mounted device for fixing a bicycle according to claim 6, wherein the upper positioning seats (55) are provided with upper pressing recesses (551), and the upper pressing recesses (551) are slidably connected to the fixing frame (1) and the connecting frame (4) in an inserted manner; and the lower positioning seats (56) are provided with lower pressing recesses (561), and the lower pressing recesses (561) are slidably connected to the fixing frame (1) and the connecting frame (4) in an inserted manner.

8. The vehicle-mounted device for fixing a bicycle according to claim 1, wherein the connecting frame (4) comprises:
connecting supports (41), wherein the connecting supports (41) are U-shaped, and the number of the connecting supports is two; and
a connecting plate (42) connected to the two connecting supports (41) separately.

9. The vehicle-mounted device for fixing a bicycle according to claim 1, wherein the angle adjustment device (2) comprises:
a rotating seat (21) arranged on the fixing frame (1);
a ratchet wheel (22) arranged on the connecting frame (4);
a pawl (23), wherein the pawl (23) is rotatably mounted on the rotating seat (21) and provided with a rocker (231); and
a spring (24), wherein the spring (24) is connected to the rotating seat (21) and the pawl (23) separately, such that the pawl (23) meshes with the ratchet wheel (22).

10. The vehicle-mounted device for fixing a bicycle according to claim 9, further comprising: a protective shell (25) arranged on the fixing frame (1), wherein the angle adjustment device (2) is located in the protective shell (25).
